(19) United States
(12) Patent Application Publication
(10) Pub. No.: US 2004/0095863 A1
(43) Pub. Date: May 20, 2004

(54) Phase lock loop for optical disc drive and optical media with wobbled grooves

(76) Inventors: Johannes J. Verboom, Colorado Springs, CO (US); Fred N. Wamble, Colorado Springs, CO (US); Kurt W. Getreuer, Colorado Springs, CO (US); Keith R. Holstine, Colorado Springs, CO (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/704,294

(22) Filed: Nov. 7, 2003

Related U.S. Application Data
(60) Provisional application No. 60/425,566, filed on Nov. 12, 2002.

(51) Int. Cl. G11B 7/00

(52) U.S. Cl. 369/47.28; 369/47.48

(57) ABSTRACT

A system and method for use in a data storage system which provides a combined phase lock loop (PLL) that utilizes a common Voltage Controlled Oscillator (VCO) and common integrator/loop-filter, but which is operational in a wobble-mode and a data-mode to provide most optimum operation and quick capture. Digital circuitry is primarily used in addition to the VCO and a loop-filter for acquiring frequency and phase lock while the optical disc drive is writing and reading. A digital Phase-detector for operation in the wobble-mode employs a down-counter that can be configured for both Frequency-Lock and Phase-Lock in a way that offers a large capture range and can adapt quickly to the multiple data-zones of the media-format.

### BACKGROUND OF THE INVENTION

The present invention relates to data storage systems. More specifically, the present invention involves a timing control system that allows for the meaningful and efficient writing and reading of data to and from a storage medium.

Optical disc drives often employ media formats that contain a wobbled groove to provide timing data. A wobbled groove is a depression in the media surface having a sinusoidal radial displacement. The wobbled groove serves as a frequency reference on unrecorded tracks and is useful in providing a media-referenced clock during data-recording. This ensures that the data is recorded at a frequency that is very close to the frequency of preformatted, or embossed, information such as header information, which typically contains Sector and Track addresses. It also ensures that the recorded data fits well in the area between such Headers thus eliminating the necessity of redundant buffer-space for absorbing frequency differences that may occur between embossed and recorded information (Such differences often result from spindle-speed tolerances, Crystal Oscillator tolerances, thermal variations and eccentricity of the tracks on the disc.)

Typically disc-formats are divided into multiple zones in order to keep the tangential density constant and thus optimizing the disc-capacity. Each of these data-zones also has it's own Wobble-frequency, with the lowest frequency at the inner radius and the highest frequency at the outer radius. A well known example of such a media-format is a DVD-RAM.

Typically drives employ a dedicated Wobble-Phase Lock Loop (PLL) to lock to the relatively low Wobble Frequency (˜300 kHz). In order to provide an appropriate frequency for data writing, the drive will multiply this frequency up to the channel-clock rate needed (factor of ˜200).

For reading the embossed headers and the recorded data, optical drives also typically employ a second PLL, i.e., the data-PLL. This data-PLL typically retrieves the channel-clock from the transitions in the embossed or recorded data, which for this purpose is usually encoded with a Run Length Limited (RLL) code. Obviously, the second PLL requires a capture process, which depends on the nature of the data being processed and the ability to reach a stable condition. However, data-PLL capture is greatly improved if the PLL's voltage controlled oscillator (VCO) frequency is already close to the frequency of the data's channel-clock at the start of the capture process. Consequently, the Wobbled groove reference may also be useful for reading data because, while coasting through unrecorded sectors, this reference can keep the Data-PLL VCO close to the actual embossed channel-clock. This would require the coordination between two separate VCOs, which would involve complex circuitry to provide this limited function.

### BRIEF SUMMARY OF THE INVENTION

The present invention provides a single integrated system and method for timing control, which utilizes a common VCO and common integrator/loop-filter to provide the functions of both the Wobble-PLL and the Data-PLL. As mentioned above, these two PLLs typically operate at very different bandwidths. Aside from the VCO and loop filter, the present invention employs primarily digital circuitry for acquiring frequency and phase lock during writing and reading, thus offering a flexible, economical and reliable solution for optical disk drives, with a minimum number of analog components.

In order to provide the comprehensive control functions of both the Wobble-PLL and the Data-PLL, the present invention utilizes the aforementioned combination of both digital and analog circuitry. The control device does include two different branches which combine to provide overall control for both modes of operation. A wobble-PLL branch includes a digital phase detector which receives the digital wobble signal. The output of the digital phase detector (i.e., a phase/frequency error signal) is provided to a multiplexer, via a lead-lag filter. The output of the multiplexer is provided to an analog section of the combined PLL which includes a digital analog converter, an integrator, and a voltage controlled oscillator. As will be appreciated by those skilled in the art, the analog section includes fairly well-known components of a PLL.

The read signal branch of the combined PLL (read-PLL branch) receives the read signal at the input of an analog to digital converter. Obviously this signal is converted to a digital signal and provided to a digital data phase detector. Similar to the Wobble-PLL, the output of the data phase detectors provided to the system multiplexer. Again, the output of the multiplexer is provided to the same analog section. In order to control the desired mode of operation, a control input is provided to the multiplexer, thus directing which input is eventually provided to the analog section. Stated alternatively, control of the multiplexer dictates which branch of the PLL is utilized (i.e., the wobble-PLL branch or the read-PLL branch), thus controlling whether the combined PLL is operating in the wobble mode or the read mode.

By combining the various inputs in this way, an integrated solution is provided for producing a timing clock signal. This integrated solution utilizes a single VCO and allows for coordinated operation in two separate modes.

In order to provide most efficient operation, the digital phase-detector of the wobble-PLL can be configured for both Frequency-Lock and Phase-Lock in a way that it offers a very large capture range and thus can adapt quickly to the multiple data-zones of the media-format. This dual configuration is made possible by the implementation of a down counter that can allow for frequency or phase lock.

### BRIEF DESCRIPTION OF THE DRAWINGS

FIG. 1 is a block diagram illustrating the combined wobble/data PLL of the invention.

FIG. 2 is a block diagram illustrating the Band Pass Filter and the Comparator used to digitize the analog sinusoidal RPP signal.

FIG. 3 is a timing diagram illustrating the timing of the two PLL modes while writing, reading headers and reading data.

FIG. 4 is a block diagram illustrating the Wobble-PLL of the invention.

FIG. 5a is a circuit diagram of the analog lead/lag filter of the invention.

FIG. 5b illustrates a bode-plot for a closed loop transfer function of the invention.

FIG. 6 is a circuit diagram illustrating the phase/frequency detector of the invention.

FIG. 7 is a timing diagram illustrating the frequency mode of the invention.

FIG. 8 is a timing diagram illustrating the phase mode of the invention.

FIG. 9 is a circuit diagram of the Lock detector of the invention.

FIG. 10 is a diagram for the digital lead/lag filter of the invention.

FIG. 11 is a graph illustrating various traces of signals generated by a model.

FIG. 12 is graph illustrating various traces of signals generated by a model on a smaller scale.

FIG. 13 is a block diagram illustrating the digital read channel of the invention.

FIG. 14 is a diagram of a digital equalizer of the invention.

FIG. 15 is a detail diagram of the phase detector of the invention.

FIG. 16 is a plot illustrating two cases of sample signals.

FIG. 17 is a diagram illustrating shoulder-samples on each side of the zero-crossings.

FIG. 18 is a diagram illustrating various signals of the PLL operation.

FIG. 19 is a block diagram illustrating an alternative combined wobble/data PLL incorporating a digital integrator.

### DETAILED DESCRIPTION OF THE INVENTION

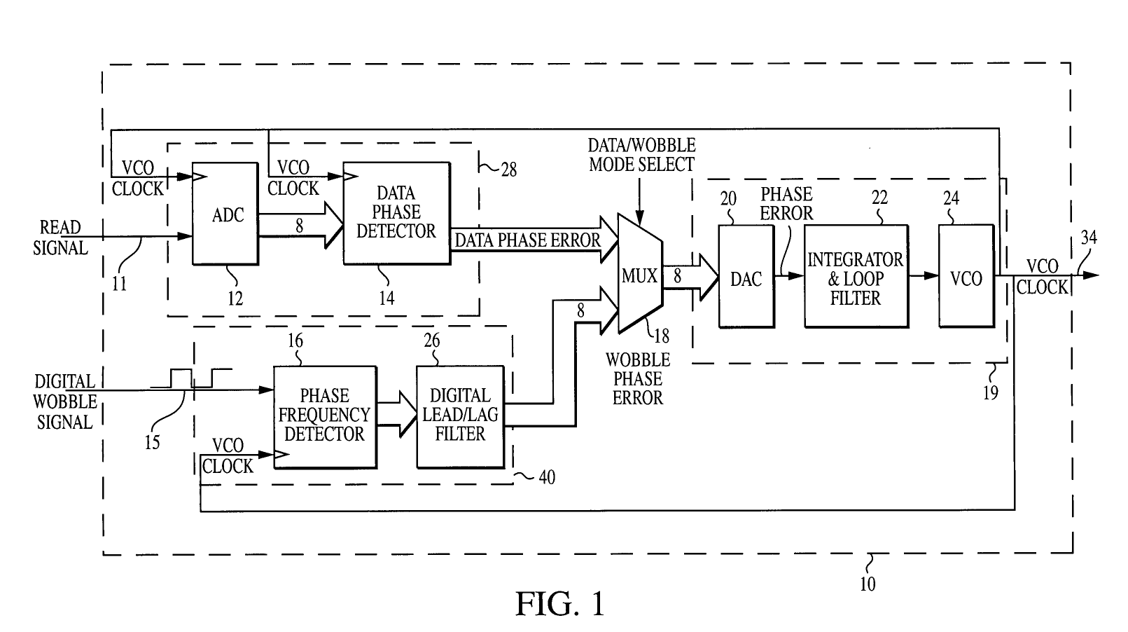

Referring now to FIG. 1, there is shown a block diagram generally illustrating a combined data/wobble PLL 10 of the preferred embodiment. As seen, combined PLL 10 has two inputs—a read signal input 11 and a digital wobble signal input 15. A VCO clock output 34 is the only output provided. (It is understood that additional control inputs may be required, which are described below.) As discussed below VCO clock output 34 will produce a clock signal that is synchronized with the media. As also discussed below, the signal processing within combined PLL 10 is primarily done digitally, thus the two input signals need to be digitized first. Read-signal input 11 is digitized by a high speed Analog-to-Digital Converter 12 (ADC), which is clocked by the VCO-clock signal or clock signal 34. Read-signal input 11, from the drive's pre-amplifier (not shown), is usually filtered to eliminate noise at frequencies outside the required bandwidth for retrieving the RLL encoded data. Thus, filter circuits are not shown in FIG. 1, but may be added if necessary.

As discussed below, the digital wobble signal is typically derived from a Radial Push-Pull signal (RPP), which is often used for tracking. The Wobble-frequency derived from the RPP signal is usually much higher than the bandwidth of the tracking-servo such that it does not interfere with the tracking servo loop. This digital wobble signal is provided to combined PLL 10 at wobble input 15.

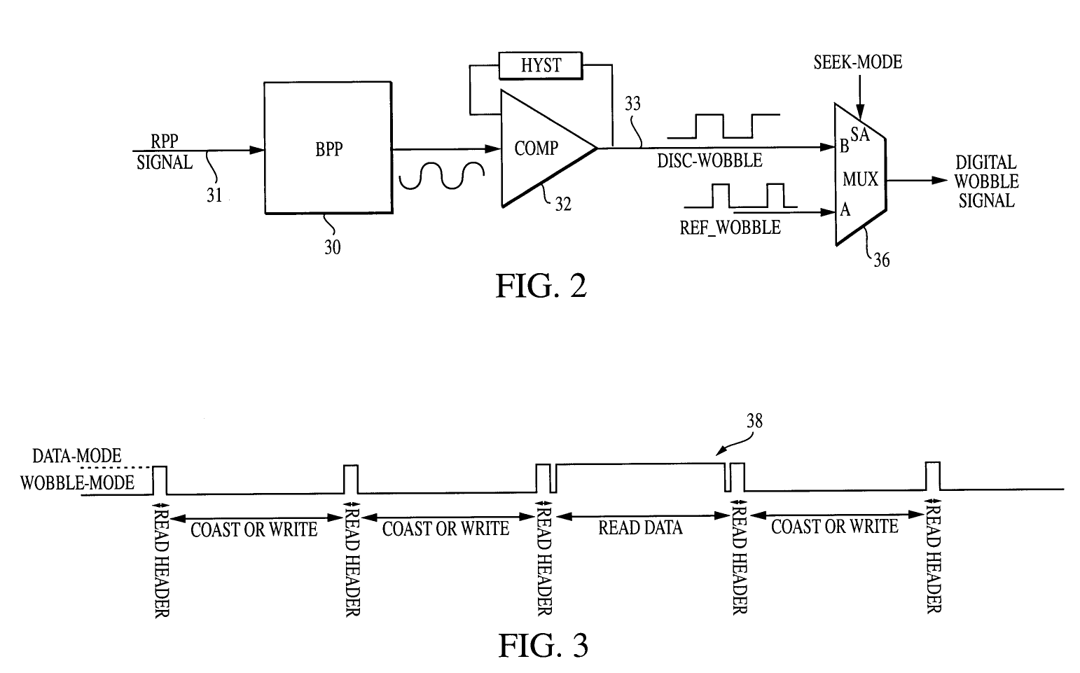

FIG. 2 illustrates the circuitry required to create the digital wobble input 15. Specifically, FIG. 2 shows a Band Pass Filter 30 and a Comparator 32 which are used to digitize the analog sinusoidal RPP signal present at filter input 31. These components create a square-wave (“Disc-Wobble”) signal. Instead of the Disc-Wobble signal, the system may select a Ref_Wobble signal while seeking to another track on the disc. The frequency of this Ref_Wobble signal is programmable and can be set close to the Wobble-frequency of the destination track. This allows the VCO to be running at a frequency close to the desired frequency when the optical head arrives at the destination track (which may be in a different data-zone). During seeks the Disk-Wobble-signal from the disc is not useable thus providing a need for the Ref_Wobble Signal.

Referring back to FIG. 1, combined PLL 10 includes two separate branches—a Wobble branch 28 and a Data branch 29. Each of these two branches utilize separate phase/frequency detectors 14, 16 to produce error signals. A multiplexer (MUX) 18 is used for selecting which branch of the combined PLL 10 will be operational. The output of MUX 18 is provided to an analog section 19 which include a Digital-to-Analog Converter (DAC) 20, an integrator & loop-filter 22 and a Voltage Controlled Oscillator or VCO 24 A DAC 20 then converts the digital appropriate error-signal into an analog signal. Also included in Combined PLL 10 is. The wobble branch 28 contains a Digital lead-Lag filter 26 to allow for the consistent use of VCO 24 in both operating modes (e.g., data mode or wobble mode). When operating in the data mode, the combined PLL 10 has a much higher bandwidth (˜100 kHz) because it must be accurately phase-locked to the recorded or embossed RLL-encoded data. The digital Lead-Lag filter 26 provides PLL stability in the wobble mode, operating at a much lower bandwidth (i.e., in the order of 3 kHz).

In FIG. 3 the timing of the two PLL modes is illustrated while writing, reading headers and reading data. When the mode select signal 38 is high, combined PLL 10 is in Data-mode. Conversely, when the mode select signal 38 is low, combined PLL 10 is in Wobble-mode. Typically, combined PLL 10 is in the wobble-mode when the optical head is simply following the track, and only switches to Data-mode at every occurrence of the relatively short headers, which provide track and sector address information to the DSP. The Groove-Wobble and the address information were mastered at the same time, and were driven by the same master-clock, thus their frequencies have a well defined relation. Consequently, the VCO stays at essentially the same frequency in these two PLL modes. The VCO-clock is fine-tuned, however, for optimal reading of the RLL-encoded data in the headers. During this header read mode, the Wobble Error signal is cleared (set to zero) and it's Lock-counter is frozen. After reading the header, Combined PLL 10 resumes its normal operation.

While writing data to the disc, Combined PLL 10 is also in Wobble-mode, except at the occurrences of the headers. This guarantees that the data is written at the proper frequency, which is synchronized to the actual media velocity. This guarantees that a recorded data-sector fits exactly in the reserved space between headers.

While reading recorded data, combined PLL 10 switches to Data-mode. As the data was written at a well defined frequency (the same as the header data frequency), the VCO is typically at the desired frequency when it starts to read the data. Consequently, only the VCO needs to lock it's phase to the data transitions. Between reading headers and reading recorded data, combined PLL 10 may briefly switch to Wobble-mode, but this time is way too short to have any effect on Combined PLL 10, so the VCO frequency remains at the frequency that it locked to during the header.

Wobble Branch Overview

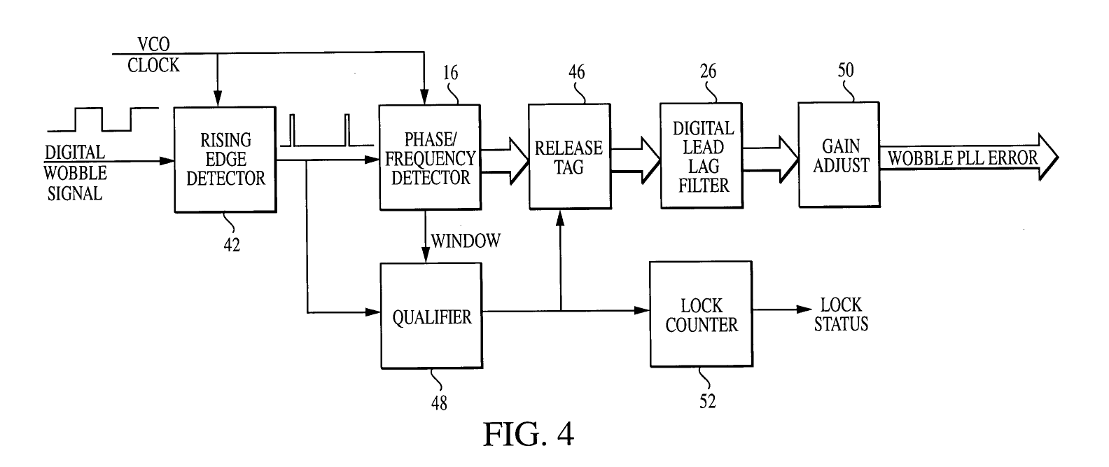

FIG. 4 shows a more detailed block-diagram of the wobble branch 40 which combines with multiplexer 18, DAC 20, integrator 22 and VCO 24 to provide operation in the Wobble mode. A rising edge detector 42 generates pulses at the rising edge of the Digital Wobble Signal. These “Wobble-pulses” are synchronized to the VCO-clock and are 1 channel-bit wide. As seen in FIG. 4, the Wobble-Pulses are provided to frequency/phase detector 16 and a qualifier 48. All of the following circuits operate synchronous to the VCO-clock (rising edge).

Phase/Frequency detector 16 has two modes, a frequency-mode and a phase-mode. The output of Phase/Frequency-detector 16 is a signed binary value that, when in phase-mode, is only copied to a release register 46 if a qualifier 48 has determined that the Wobble-pulse occurred within the window provided by the timer in the phase/frequency-detector 16. Otherwise the release register 46 is cleared such that no false phase information enters the subsequent circuitry. In frequency-mode phase/frequency detector 16 output is released unconditionally. The lead and lag frequencies of digital lead/lag filter 26 are programmable. A gain adjust circuit 50 allows a programmable gain for wobble branch 40. Lastly, a lock-counter 52 (up/down) provides a lock-status signal to the DSP and determines when to switch from frequency-mode to phase-mode.

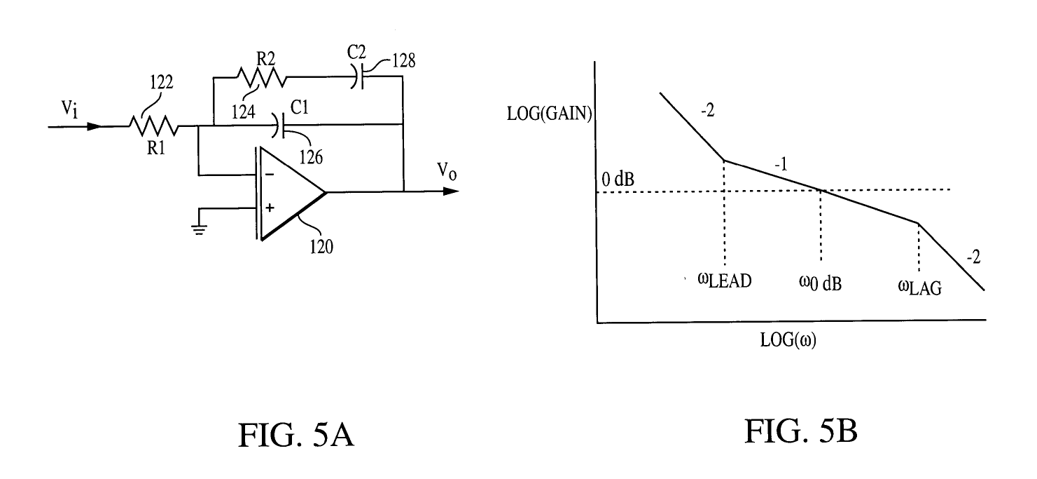

As was mentioned above, combined PLL 10 operates at a much lower bandwidth when operating in the wobble-mode as compared to the data-mode. This is basically dictated by the input signal to the wobble branch 40 which provides much fewer phase/frequency updates than the input signal to the data branch 28. In order to provide good loop-stability in both modes two separate lead/lag filters are needed. The lead/lag for use in the data-mode is provided in integrator and loop filter 22 that drives the VCO 24. A typical implementation of this circuitry is illustrated in FIG. 5A. As can be seen, this is a fairly well-known circuit configuration to achieve the desired filtering function, utilizing an amplifier 120, a first resistor 122, a second resistor 124, a first capacitor 126, and a second capacitor 128. The resulting filter function is then:

$$\frac{{V}_{0}}{{V}_{i}} = \frac{- 1}{s \cdot {R}_{1} \cdot ( {C}_{1} + {C}_{2} )} * \frac{s \cdot {R}_{2} \cdot {C}_{2} + 1}{s \cdot {R}_{2} \cdot ( \frac{{C}_{1} \cdot {C}_{2}}{{C}_{1} + {C}_{2}} ) + 1}$$

FIG. 5B includes an example of a bode-plot for the closed loop transfer function of the desired lead/lag filter. For operation at a bandwidth of 100 kHz, a lead frequency of 30 kHz and a lag frequency of 300 kHz work well. However, the wobble-mode must operate at a bandwidth of about 3 kHz, which requires a lead frequency of ˜1 kHz and a lag frequency of ˜10 kHz. To accommodate both operation modes, one option is to add a second analog lead/lag filter to the circuit of FIG. 5A with appropriate analog switches to select the desired configuration. A preferred solution, however, is to employ digital lead/lag filter 26, which is operational in the wobble-mode, thus also offering more flexibility by providing programmable lead/lag parameters and a programmable loop-gain. This flexibility is especially beneficial for a media format with multiple zones because it allows optimization of the wobble-mode for the various wobble frequencies in those zones. As the combined PLL 10 operates in the wobble-mode at a relatively low bandwidth, the digital implementation of this filter is easily done with state-of-the art digital ASIC technology.

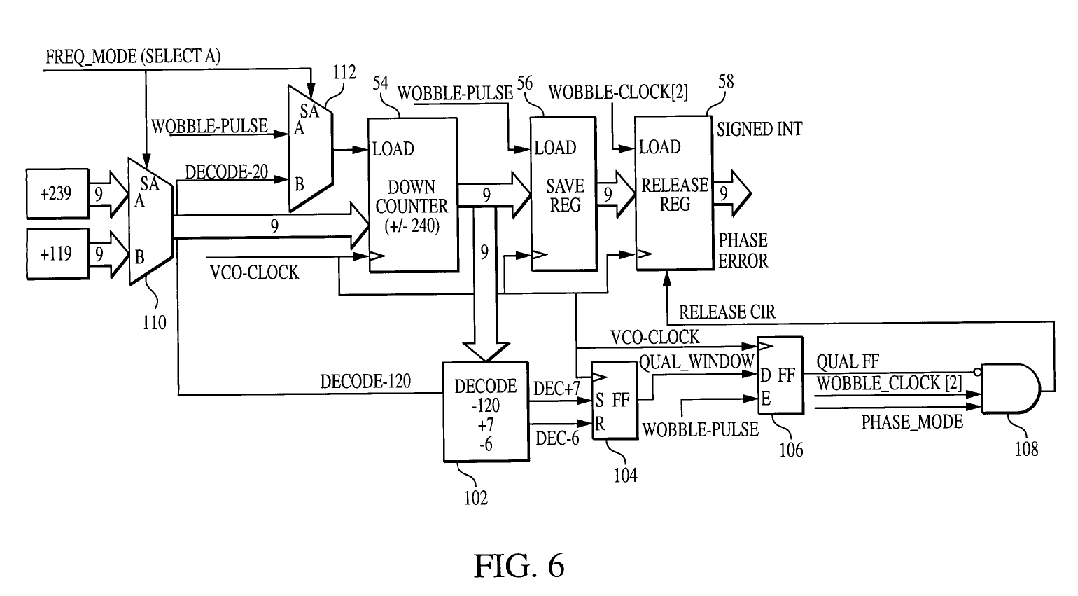

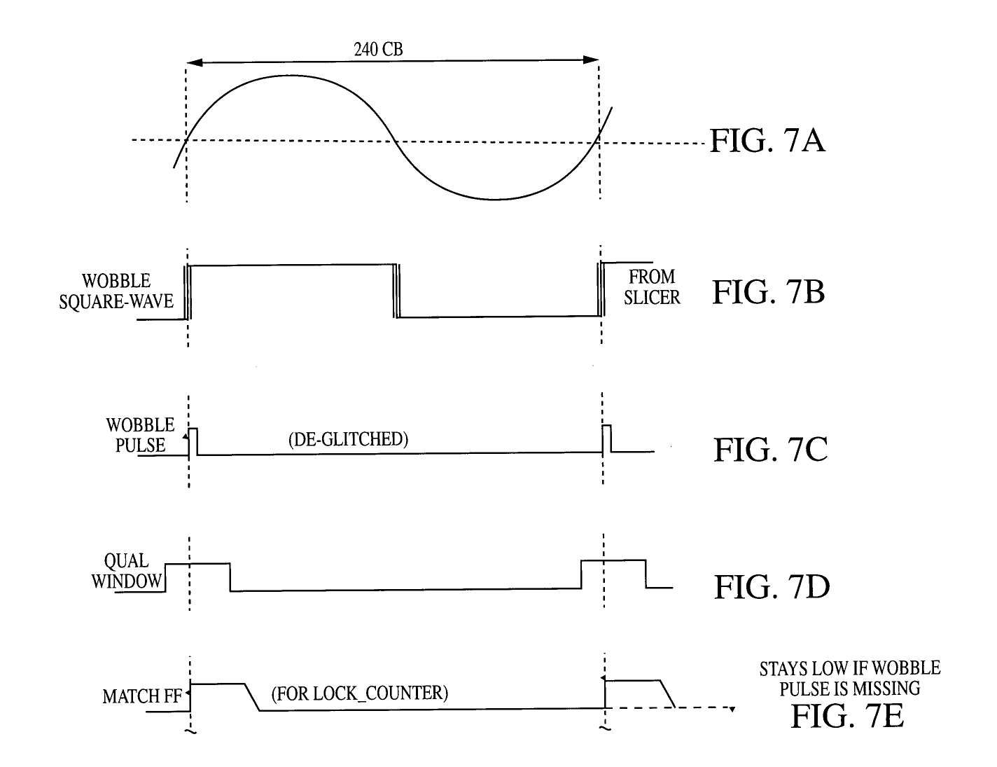

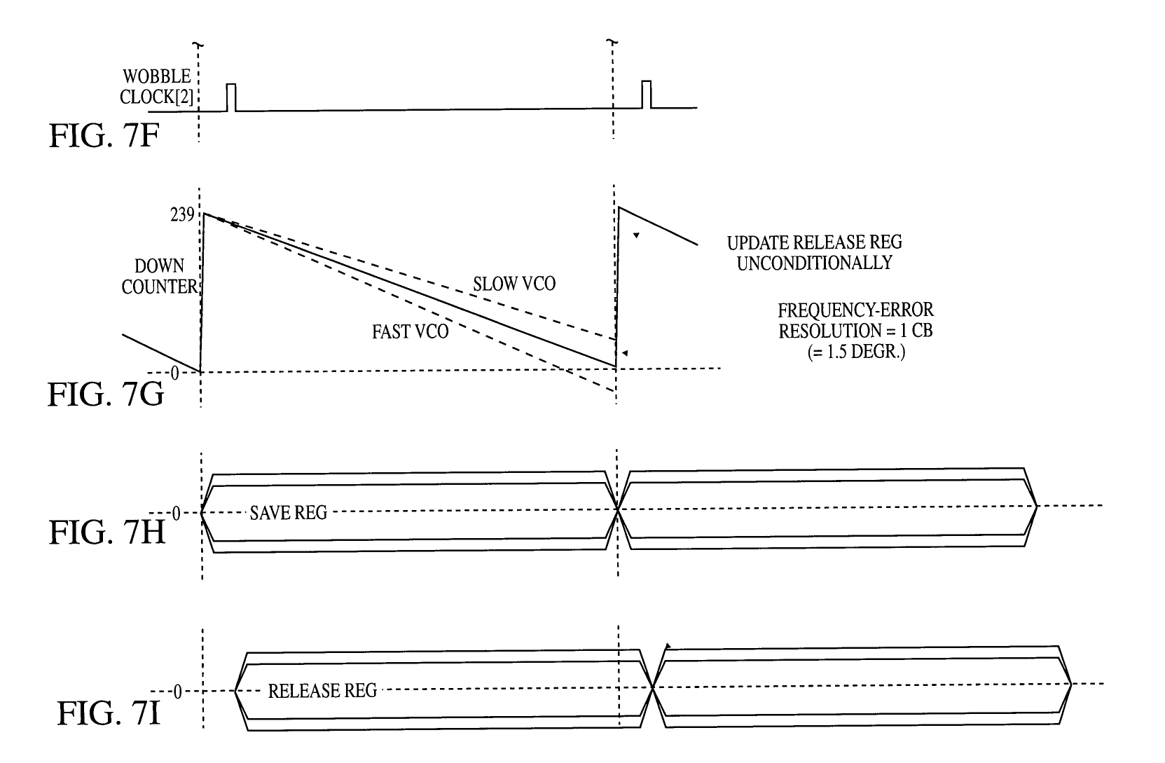

As mentioned above, combined PLL 10 includes phase/frequency detector 16 and qualifier 48, which are operational in the wobble-mode. The core of these two elements is a down-counter 54 that is clocked by the VCO-clock. FIG. 6 shows a functional block diagram for this circuit, while FIG. 7 shows a corresponding timing diagram for the frequency-mode.

As illustrated in FIG. 7, one Wobble-period contains 240 channel-clocks (a.k.a. channel-bits or CB). The Wobble-pulse (c) is derived from the rising edges of the Wobble Square-wave (b) and is synchronized to the VCO-clock to be one (1) channel-bit long. The Wobble-pulse (c) sets the Down-counter to 239. (In frequency-mode the down-counter is set to one value by each Wobble-pulse, while in phase-mode the down-counter is set to another value.) Subsequently counter 54 starts counting down on each VCO-clock. If the VCO is running at the exact correct frequency then the counter will be at zero just before the next Wobble-pulse arrives. If the VCO is running slow then the counter will be at a positive value at the next Wobble-pulse and if the VCO is running fast then the counter will be at a negative value at the next Wobble-pulse. At each Wobble-pulse the value of the counter is saved in a save register 56. In this mode the save register 56 is unconditionally copied to a release register 46. The value saved in release register is used as the Error-value for driving the VCO to the right frequency, but only after some additional signal processing (i.e., operation of digital lead/log filter 26 and gain adjust 50). The Wobble-Clock[2] (f) is basically the Wobble-Pulse (c) delayed by two VCO-clock cycles.

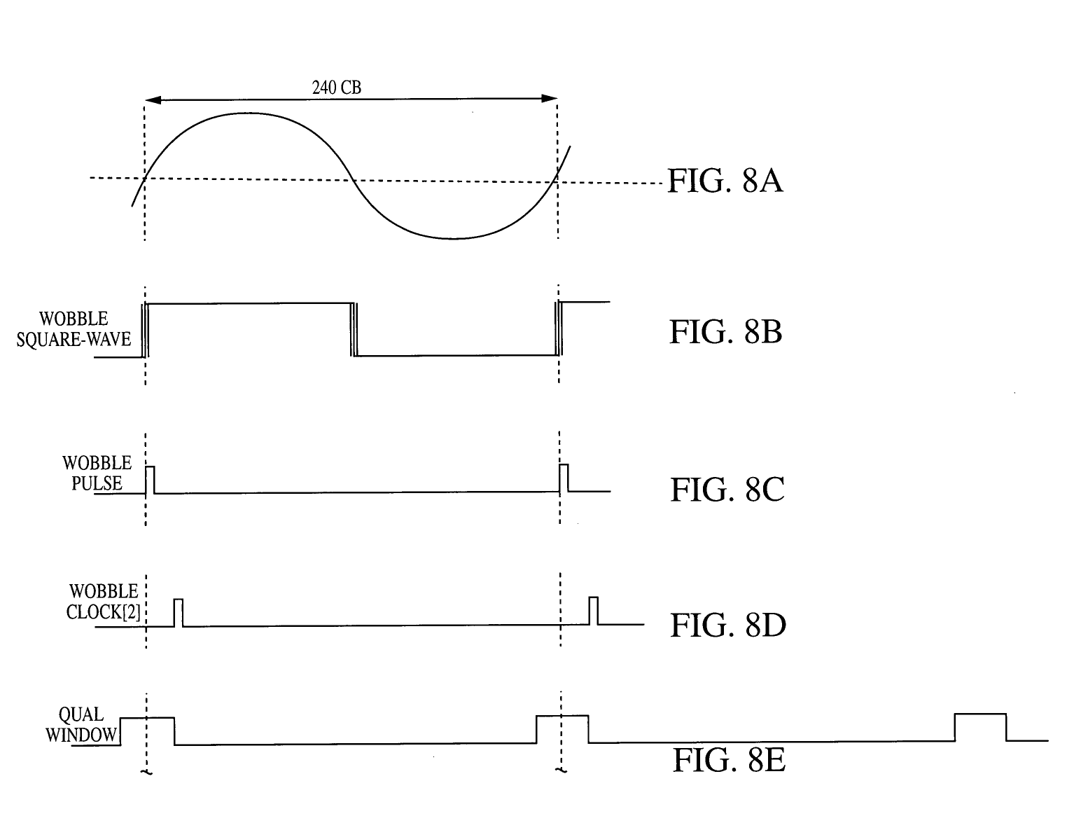

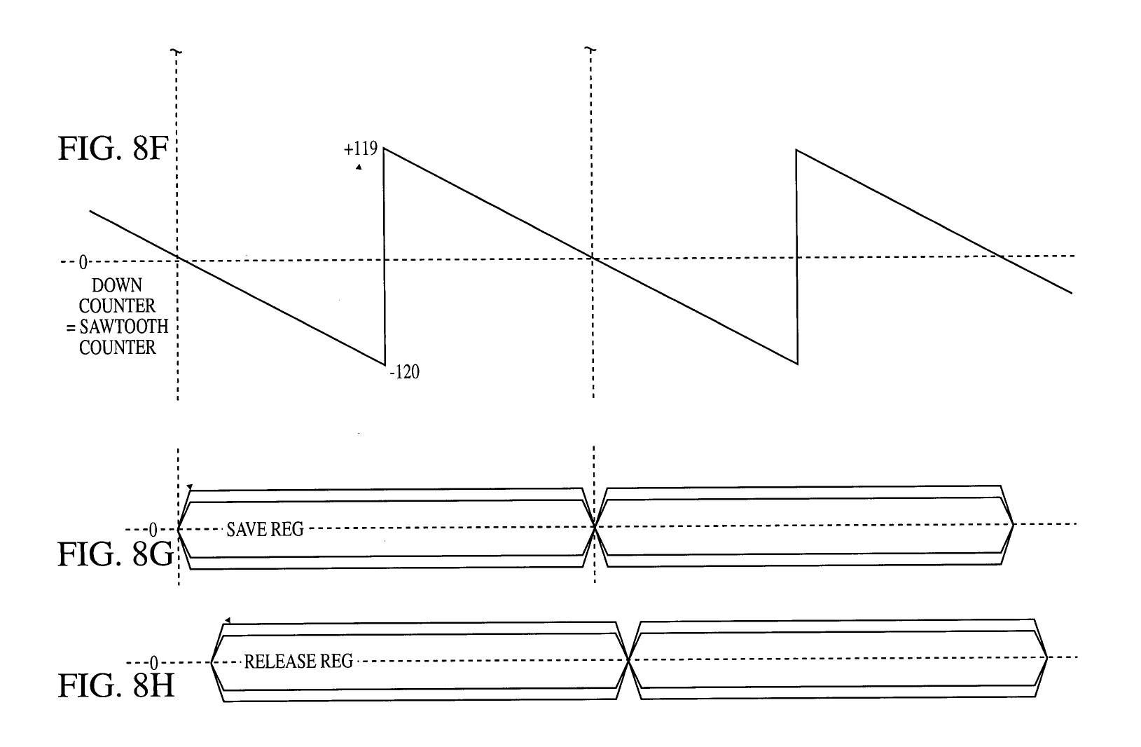

FIG. 8 shows a timing diagram of phase/frequency detector 16 operating in the Phase-mode. In this mode down-counter 54 automatically wraps, every 240 channel-clocks, from −120 to +119 as shown in FIG. 8(f). After switching from frequency-mode to phase-mode, the Wobble-Pulse may not exactly line up with the counter-value of zero and it may even be outside the Qual-Window (shown at FIG. 8(e)) that is derived from down-counter 54. In this example the Qual-window is high for counter values +6 through −6. Therefore the Qual-Window is ignored until phase lock has been established. When the Wobble-Pulse occurs, the value stored in down-counter 54 is loaded into save-register 56 and later copied to release register 46, to serve as a raw PLL Error value. If the Wobble-pulse arrives after the zero-crossing of the down-counter (f) then a negative value is saved, causing the VCO to slow down a bit. If the Wobble-pulse arrives before the zero-crossing of the Down-counter then a positive value is saved, causing the VCO to speed up a bit. With proper settings for loop-gain and lead-lag filter, down-counter 54 (driven by the VCO-clock) will soon line up its zero-values with the occurrences of the Wobble-Pulse (c) (from the media), resulting in an average PLL Error value of zero. Once phase lock has been established, the Qual-Window (e) becomes a condition for releasing the error value to the lead/lag filter 26. If no Wobble-pulse (c) occurs within this Window, then release register 46 is cleared to zero. This prevents media defects, which potentially cause false Wobble Pulses from disturbing operation of combined PLL 10.

Referring again to FIG. 6, the various components enabling the above operation are shown. More specifically, decoder 102 receives signals from down counter 54 in order to produce pulses for the phase mode (i.e., decode −120) and to produce Qual Window (e) signals. Specifically, decoder 102 feeds a decoder +7 and a decoder −6 signal to flip-flop 104 which consequently produces the Qual Window signal. This Qual Window signal is then provided to a second flip-flop 106. Second flip-flop 106 also receives the wobble-pulse signal and ensures that the wobble-pulse is within the Qual Window. This then allows gate 108 to control whether the release register value should be used or should be cleared.

Also note that FIG. 6 includes a first multiplexer 110 and a second multiplexer 112 used to provide appropriate inputs to down counter 54, depending upon the desired mode of operation. This is controlled by the freq_mode signal.

Lock Detector

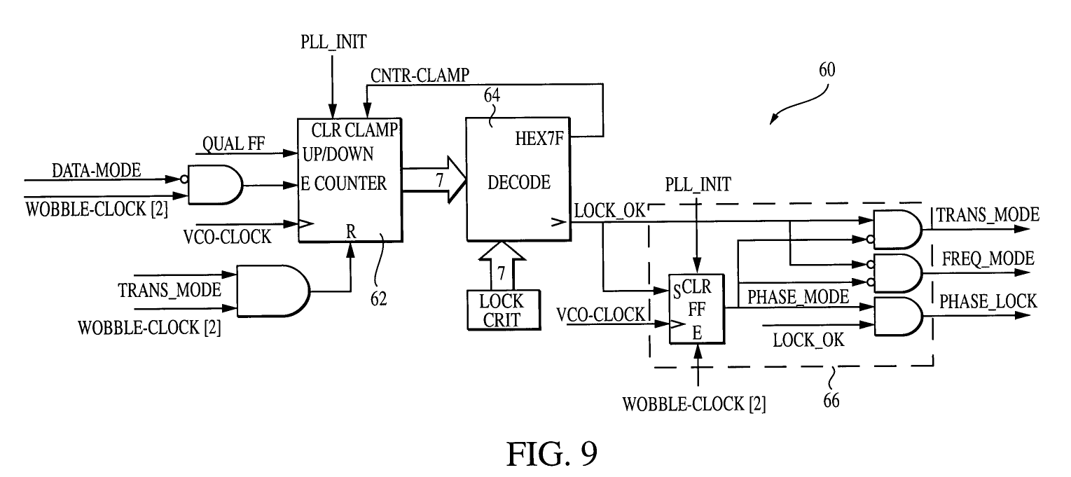

FIG. 9 shows a lock detector circuit 60 used by combined PLL 10 to determine lock status. Lock detector 60 includes an up/down counter 62, which counts up if the Wobble-pulse is inside the Qual-window and counts down if the Wobble-pulse is outside this window. Up/down counter 62 is clamped to zero on the low end and to 127 on the high end. The Lock-OK status, output from decoder 64, goes high if the up/down counter 62 exceeds the Lock criterion, which is programmable and typically set to 100. Once Lock-OK status high, wobble branch 40 switches from Frequency-mode to Phase-mode after the next Wobble-pulse. This status change is accomplished by appropriate signals being produced by a logic network 66. During the transition from frequency-mode to Phase-mode, Lock-counter 62 is set to zero. In Data-mode Lock-counter 62 is frozen.

Lead/Lag Filter

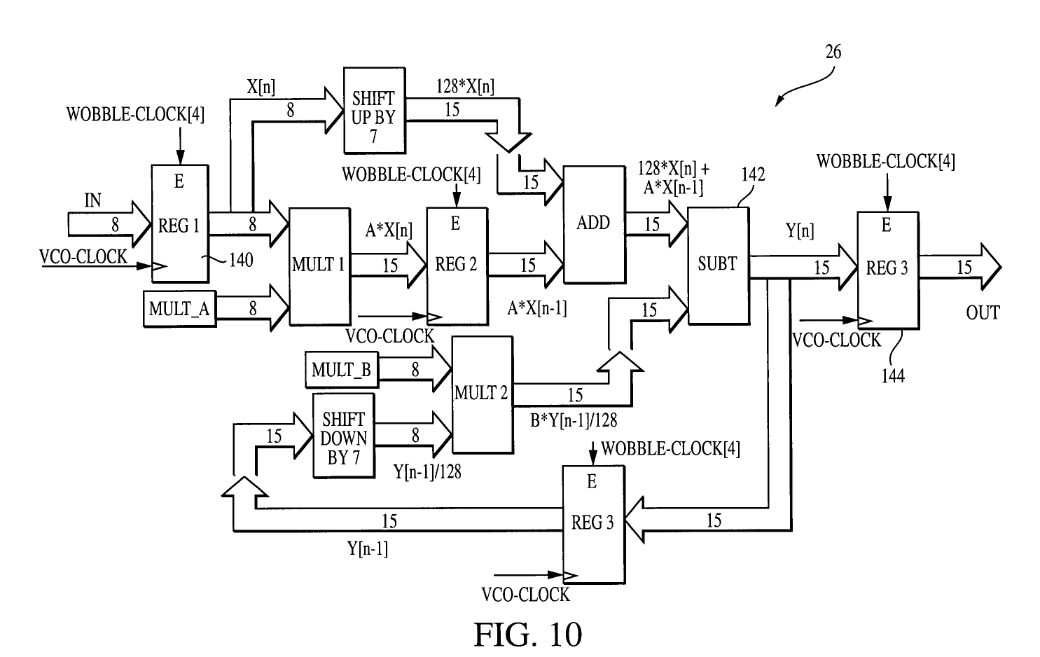

As mentioned above, lead/lag filter 26 is required to allow coordinated operation of both wobble branch 40 and data branch 28. FIG. 10 shows a more detailed diagram for Lead/Lag filter 26. Generally speaking, the filter implements the following function:

Yn=128*Xn+(A*Xn−1)−(B*Yn−1/128)

Where Xn is the output from Register 140 (Reg. 1) and Yn is the output from the Subtractor 142 (SubT). The input to Lead/Lag filter 26 is provided to Register 140 in order to provide synchronization with the previous stage. Yn is provided to Register 144 (Reg 4) to produce an output. The use of Reg 144 offers a glitch-free buffer for the next stage. Note that output Yn is a 15 bit value, while input Xn is a 8-bit value. Yn can be shifted down for the desired gain. A and B are negative coefficients >−128.

In the frequency domain lead/lag filter 26 provides the following transfer function:

H(s)=(1+a* exp(−s*T))/(1+b* exp(−s*T))

Where T is the Wobble period in sec. Typically a and b are negative coefficients >−1 and <0. This results in the following values:

A=integer(128*a) B=integer(128*b)

which are utilized by lead/lag filter 26. As is seen by referring again to FIG. 10, a number of common logic components are utilized to carryout the transfer function mentioned above.

Gain Adjust Stage

As is always the case with control loops, the gain of the loop must be set correctly in order to obtain the desired response of the combined PLL 10. The above-described design offers two options for gain control. For coarse gain changes (in factors of 2), the Filter Output can be shifted down by a programmable number of bits. For fine gain settings, the Wobble PLL error signal can be set to zero after a programmable number of VCO-clock cycles from its last update, thus offering a gain variation of 0 to 240 in single step increments. In essence this provides pulse-length modulation for the phase error signal.

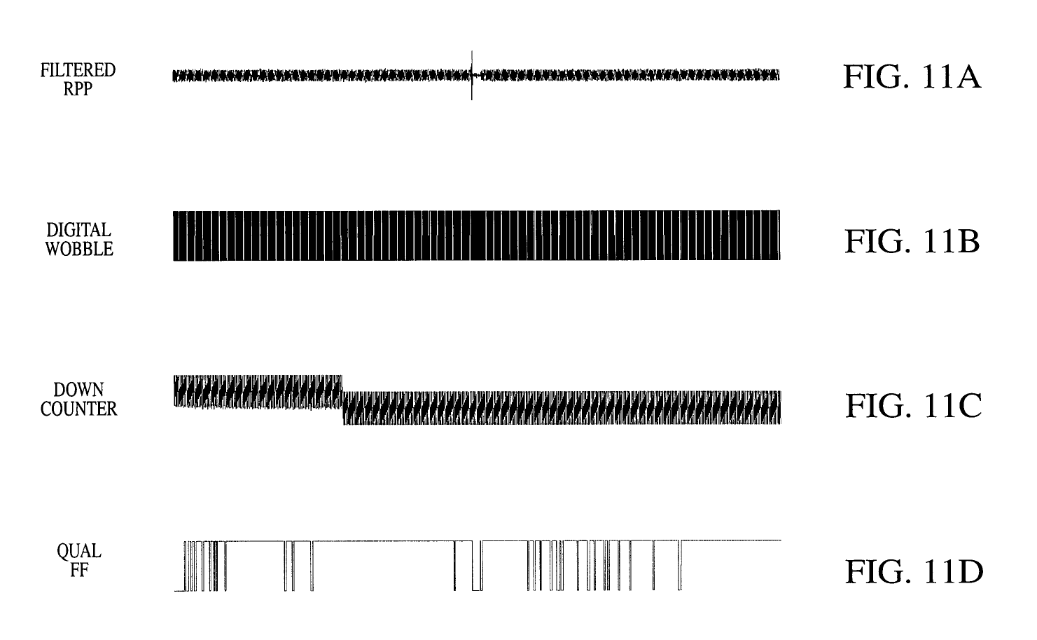

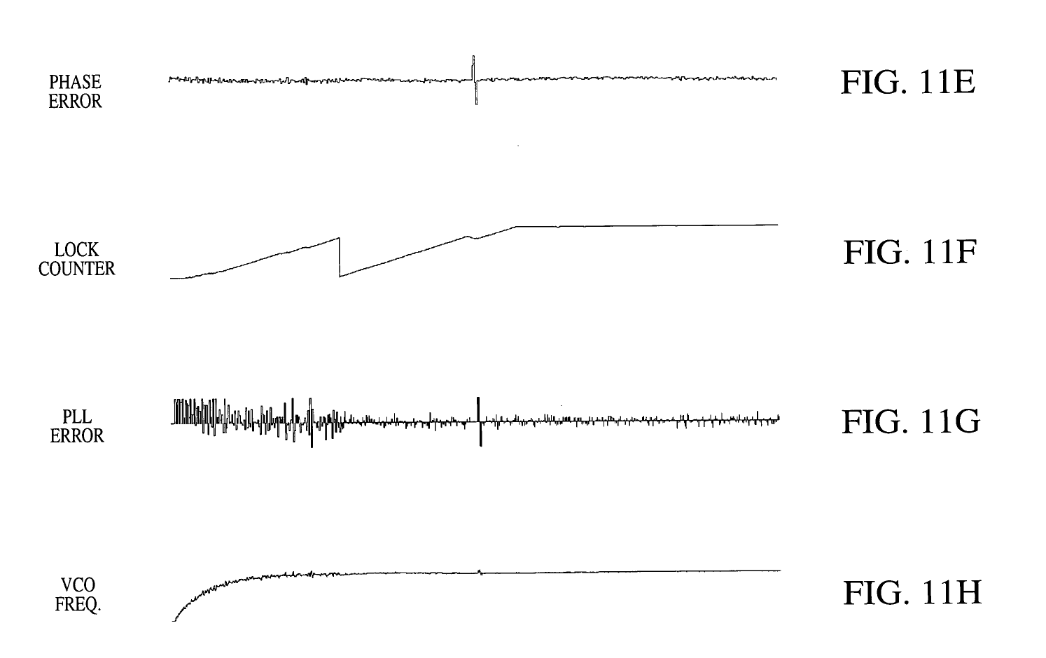

FIG. 11 shows various signals generated by combined PLL 10 during operation. The first trace 11(a) shows a typical RPP signal 31 received by combined PPL 10. The second trace 11(b) shows the Digital Wobble as derived from the RPP signal 31. The third trace 11(c) shows the Phase/Frequency detector's down-counter. The fourth trace 11(d) shows the Qual_FF. The fifth trace 11(e) shows the Phase-Error signal from the Phase/Frequency detector. The sixth trace 11(f) shows the Lock-counter status. The seventh trace 11(g) shows the PLL-Error signal after lead/lag filter 26 and the Gain Adjust stage. The eighth trace 11(h) shows the VCO frequency.

In FIG. 11, the combined PLL 10 is first initialized, which puts the wobble branch 40 in Frequency mode. At each Wobble-pulse the down-counter is set to 240 and its last value (prior to the preset) is used for driving the VCO frequency up. As the VCO frequency starts to approach the target frequency, the Qual_FF is high more often, causing the Lock-counter to count up. When the Lock-counter reaches a value of 100, the wobble branch 4 is switched to Phase-mode and the Lock-counter is cleared. Next, the Down-counter starts wrapping from −120 to +119, thus creating a saw-tooth with exactly 240 VCO-clock cycles. The Phase Error value now depends on where the Wobble-pulse occurs with respect to the saw-tooth. When the Lock-counter reaches 100 again, the wobble branch is considered to be in Phase-Lock. This status may be used to switch to a slightly lower gain for better stability.

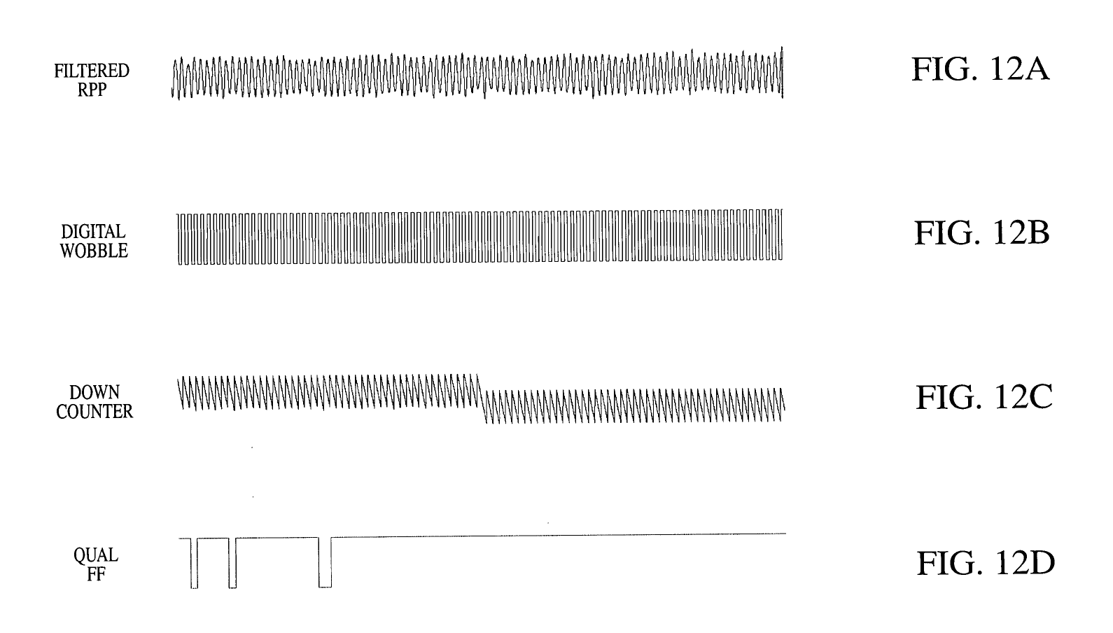

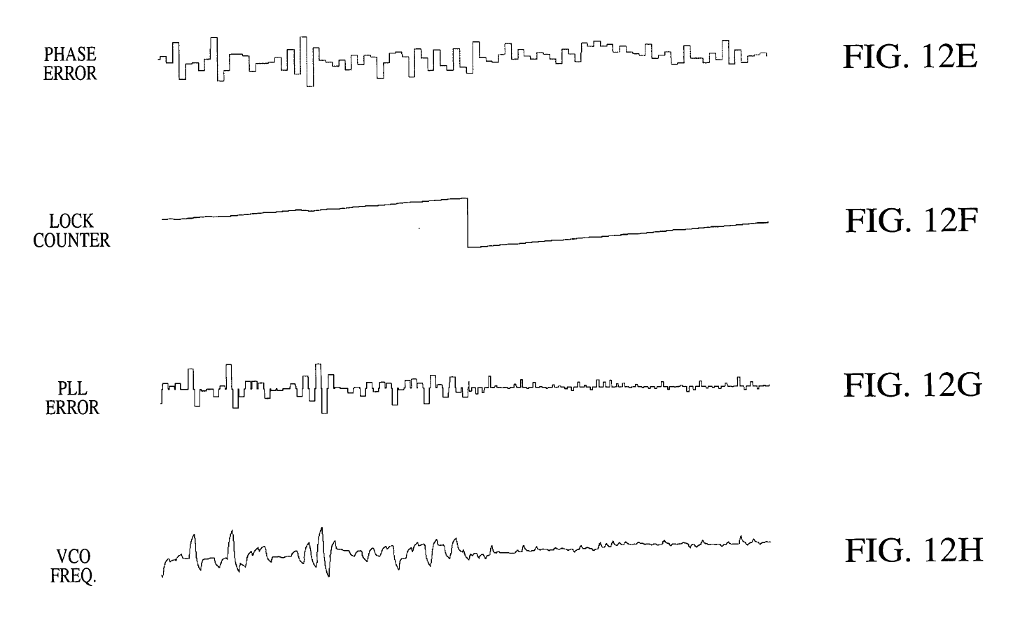

FIG. 12 shows the same signals, but on a much smaller time-scale around the switch from Frequency-mode to Phase-mode.

Data Branch

As mentioned above, FIG. 1 illustrates a block diagram for the combined Data/Wobble PLL 10. The data branch 28, which is operational in the data mode, includes Data Phase Detector 14 that processes the output of the high speed ADC 12. In data mode, the combined PLL will lack VCO 24 to information contained on the media.

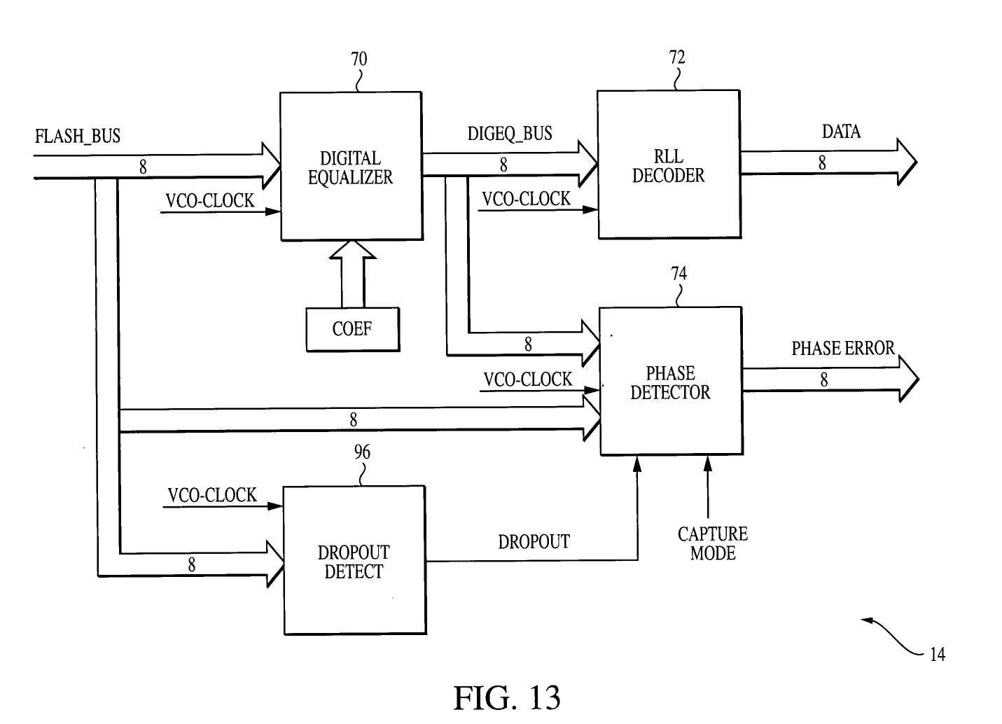

FIG. 13 portrays a more detailed block diagram of data phase detector 14. The output of the high speed ADC 12 (Flash_bus) goes via a digital equalizer 70 to the RLL decoder 72, which converts the channel-bit values to byte-wise data. Phase Detector 14 can either use the Flash_bus or the DigEq_bus for extracting the Phase error signal. As the RLL decoder 72 uses the equalized signal, the preferred signal for Phase detector 14 is also the DigEq_bus. However this signal is delayed by several clock-cycles in a practical implementation.

Digital Equalizer

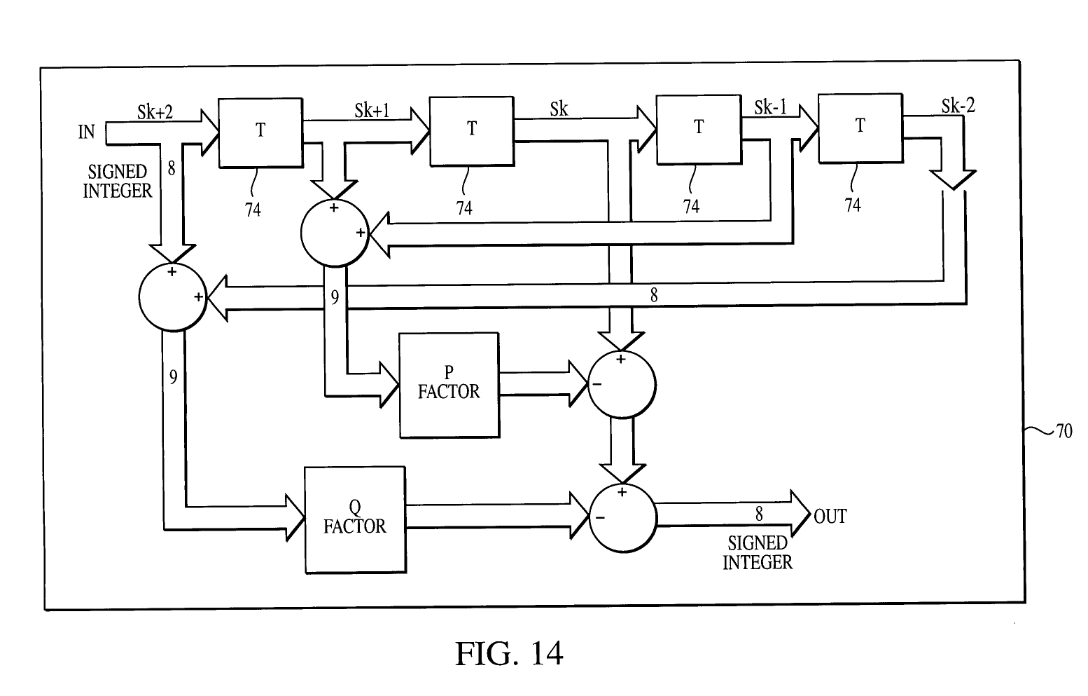

FIG. 14 is an example of a 5-tap digital equalizer 70 (a.k.a. Transversal Filter or FIR-filter). Factors P and Q are programmable and have values <1 and >0. The T-blocks 74 have one clock-cycle delay and for glitch-free timing considerations each arithmetic operation is followed by a clocked register thus also causing one clock-cycle of delay. This adds up to a delay of several clock-cycles, which is particularly undesirable during the phase-capture mode, because for phase-capture one wants to use a higher bandwidth (fast response) than in normal (phase-locked) mode. However, for optimal RLL decoding performance the VCO-clock should be optimized for the equalized signal.

As can be seen by following through the operation of digital equalizer 70, the output is dictated by the following equation: OUT=Sk−P (Sk−1+Sk+1)−Q (Sk−2+Sk+2). Where Sk is the clocked output signal which was present at the input to previous clock cycles. From this, it can be seen that digital equalizer 70 avoids glitches and undesirable data jumps.

Preamble Phase Detector

Typically the encoded data in each sector on the disc is preceded by a Preamble, which usually consists of a repetitive mark-space pattern (e.g. a 3T-3T pattern). During reading of this Preamble the combined PLL 10 is in capture mode, so it uses the Flash_bus input.

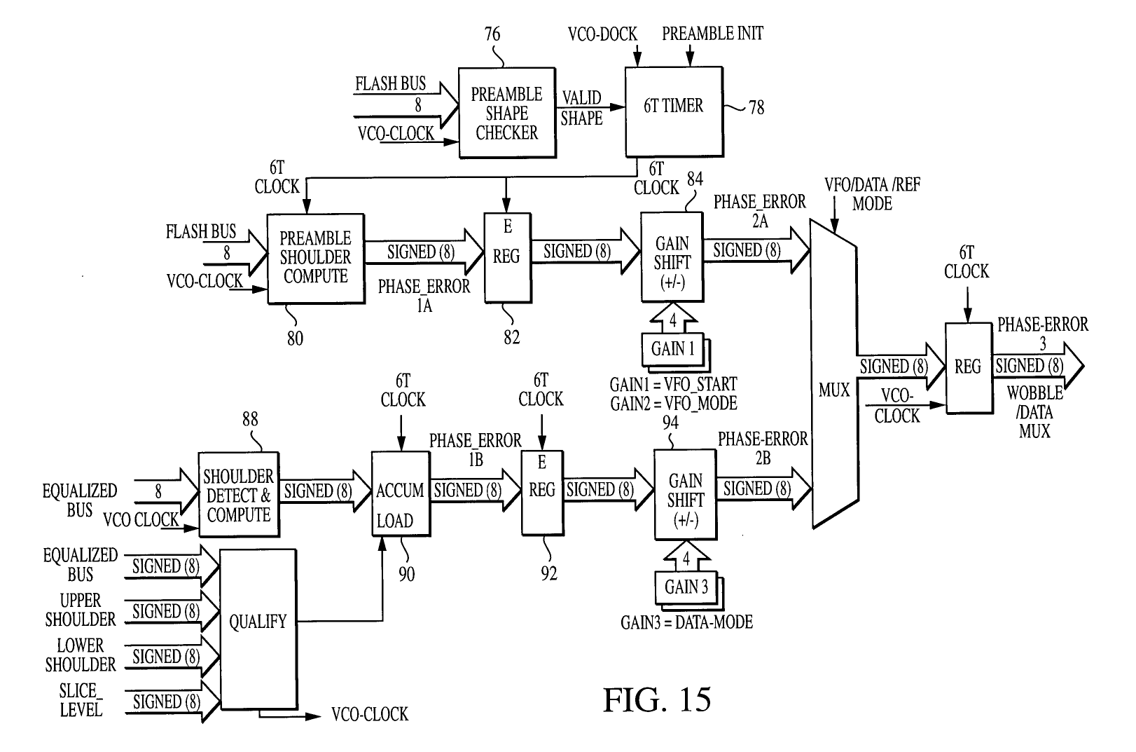

FIG. 15 shows the Phase Detector 74 in more detail. The upper part is for PLL capture in the Preamble. First, the Preamble shape-checker 76 looks for a valid 3T-3T pattern. Because of the Wobble-PLL the VCO-clock is already at the right frequency, so the Preamble-pattern should be easy to recognize.

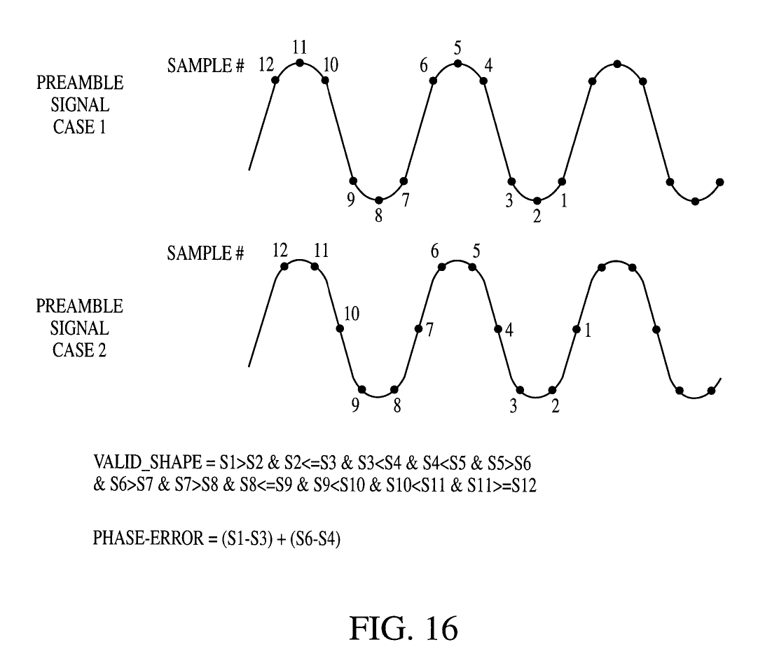

FIG. 16 illustrates graphically how preamble Shape-Checker 76 operates. It shows two cases of initial sample-phases of the 3T waveform, indicated by the dots. In both cases the Valid_shape signal is true as soon as samples 1 through 12 are clocked into the Preamble shape-checker 76. Once a valid shape has been detected, the 6T timer 78 starts to generate a pulse every 6 clock-cycles. This 6T-clock is used to update several other stages. The choice of the 6T update rate is dictated by the speed of the DAC that drives analog integrator/loop-filter 22.

After the first Valid-Shape, the Shoulder-Processor 80 computes a phase-error_{—}1A as shown in FIG. 16. As indicated phase-error_{—}1A is computed as:

Phase-error_{—}1A=(S1−S3)+(S6−S4).

In case 1, this phase-error is close to zero, while in case 2 the phase-error is very high. The goal of the data branch 28 is to make the two upper shoulders and the two lower shoulders equal (like case 1). The phase-error_{—}1A signal in FIG. 15 can be shifted up or down to change the loop-gain in factors of 2 using gain shift 84. This gain-setting is programmable and, the Preamble and Data-field each have their own gain-setting that is switched at the end of the Preamble. The next stage is a buffer register 86 (updated on every 6T-clock) that drives the DAC 20, but via the Wobble/Data multiplexer 18 of FIG. 1.

Data Phase Detector

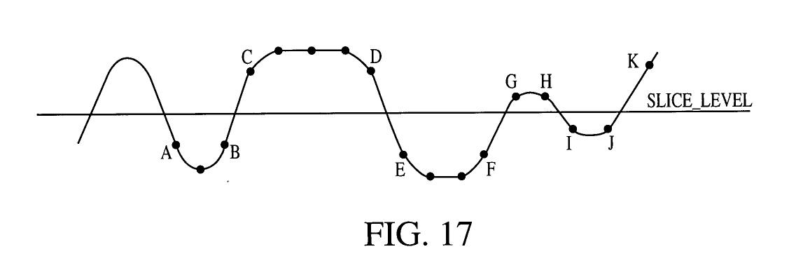

Referring back to FIG. 15, the Data-Field section of phase-detector 74 can be seen in the lower part of the figure. As in the preamble phase detector, this part uses the DigEq_bus. The phase-error is also derived from the shoulders of the marks and spaces in the data. However, in the Data-Field the mark and space-lengths are unpredictable, although bounded by maximum and minimum run-lengths, as dictated by the Run-Length Limited (RLL) encoding. So the location of the shoulder-samples must first be found. This is accomplished by finding the zero-crossings in the channel-bit stream using shoulder detect & compute 88. The shoulder-samples are on each side of the zero-crossings, which is shown in FIG. 17.

After the rising zero-crossing, the difference of the space-shoulders (B-A) is taken, while saving sample C for later. After the falling zero-crossing the difference of the mark-shoulders (C-D) is taken, while saving sample E for later. The differences (B-A) and (C-D) are accumulated in the Accumulator 90 until a 6T-clock clears it. But just before being cleared, the Accumulator value is saved in a register 92 and its output becomes Phase-error_{—}1B for one 6T period. This Data-Field path has its own programmable gain-shift from gain shift 94.

The update rate for the DAC is fixed at a 6T interval. Variations in the rate of transitions in the Data-Field are absorbed by the Accumulator 90. During run-lengths of >6T, the accumulator 90 stays at zero, so the next phase-error_{—}1B signal will be at zero for one 6T period. Note that the maximum run-length is 8T and the minimum run-length is 2T in RLL encoded data for the 1,7RLL-code.

FIG. 17 also illustrates a couple of 2T runs (samples G-J). In this example, samples G-J are nicely centered around the Slice_level (typically at zero) and they have a substantial amplitude. However, in the real world this is not always the case. The 2T runs often have a very small amplitude due to Inter-Symbol Interference (ISI) and are also subject to offsets (a.k.a. asymmetry) due to non-optimal write-power or non-optimal write pulse timing. For the RLL decoding purpose these problems may be overcome by applying Selective Inter-Symbol Interference Cancellation techniques. (See U.S. Pat. Nos. 6,205,103 and 6,118,746 for additional information regarding these techniques). A similar algorithm can be used in the Data Phase Detector 14 for recognizing the 2T runs and subsequently for using the appropriate samples for phase information. In the above example, the appropriate Phase errors would be (G-H) and (J-I). The algorithm for the 2T run detection can be written in C++ code an example of which is illustrated in the attached Appendix. However, it would be known by one skilled in the art, to convert the algorithm for 2T run detection to an ASIC design language like VHDL.

Generally speaking, the above-referenced algorithm simply provides additional precision and accuracy in dealing with 2T runs. The 2T runs are appropriately identified and the relational characteristics regarding these characteristics are examined. Further, appropriate shoulder samples are stored for use at later points in time.

Dropout Detector

The signals read from optical disks are often distorted by debris on the entrance surface and by defects in the recording layer. To prevent the VCO from being erroneously driven to a wrong frequency due to these media defects, a Dropout Detector 96 (shown in FIG. 13) is employed to keep the phase-error signal at zero during these events, thus freezing the VCO frequency until the end of the Dropout. The Dropout Detector 96 basically checks the distance between transitions (i.e., zero-crossings) in the Flash_bus signal and if the maximum run-length of the RLL-code is exceeded by a predetermined number of clock-cycles (programmable), then the phase detector output is cleared to zero, until the end of the Dropout is detected after counting a predetermined number of transitions in the Flash_bus signal.

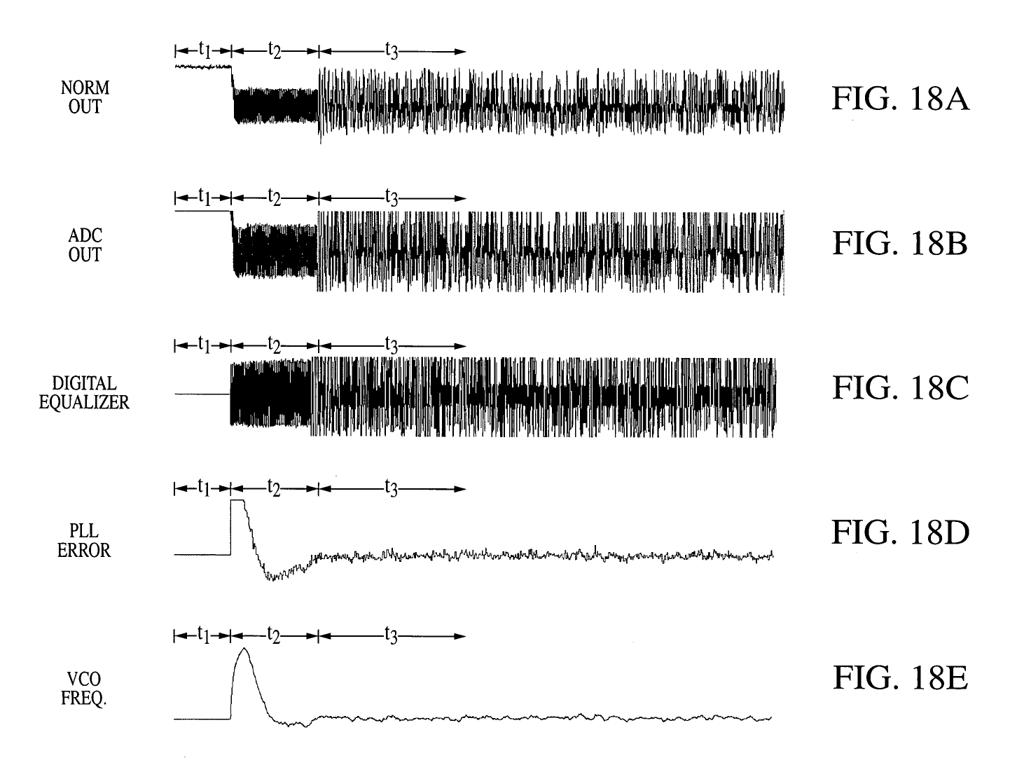

FIG. 18 illustrates several signals as they occur during PLL operation on the first portion of a captured sector. The first trace (a) shows the analog input signal to the ADC. The second trace (b) shows the output of the ADC (i.e., the Flash_bus data). The third trace (c) shows the output of the digital equalizer (i.e., the DigEq_bus). The fourth trace (d) shows the PLL error, i.e., the Phase_Error signal. Lastly, the fifth trace (e) shows the VCO frequency in MHz.

The preamble is the time period t2 with the fixed frequency, while t1 is a blank area before the Preamble. The PLL error trace shows that after the Valid_shape detection the phase error is very large and therefore the VCO is temporarily driven to a higher frequency. This is shown during time period t2. A little later the phase error goes down and after a small overshoot the PLL capture is complete. As soon as the Data-Field starts the Data-PLL switches to Data-mode and starts using the DigEq_bus. From that point on (during time period t3) the VCO frequency is maintained fairly constant.

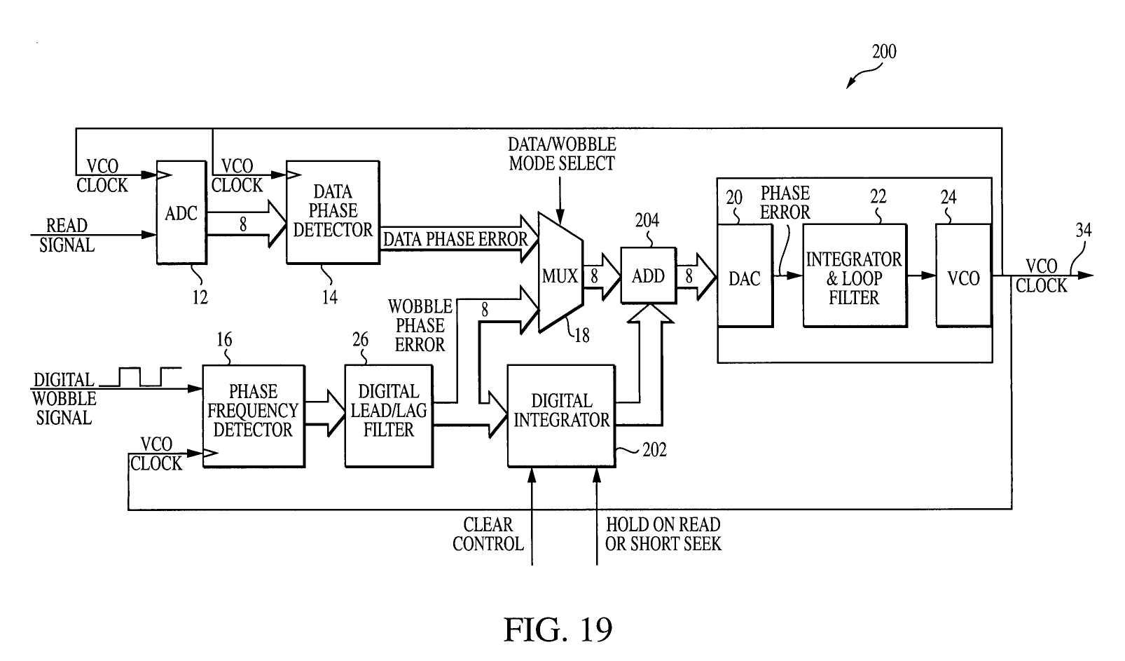

Referring now to FIG. 19, there is shown a block diagram for an alternative combined PLL 200. Generally speaking, this alternative combined PLL 200 incorporates the same concepts and method of operation as the combined data/wobble PLL 10 shown in FIG. 1 and described above. However, a digital integrator 202 and an adder 204 are added to the circuitry. As can be seen in FIG. 19, other components which are similar to those disclosed in FIG. 1 have retained the same reference numbers.

During operation of combined PLL 200, leakage current can some times exist in integrator 22. This leakage current causes a false error signal to be provided to the VCO 24 in order to adjust for this leakage current, digital integrator 202 is added. This correction signal is then provided to an adder 204 for its incorporation into the resulting error signal transmitted by multiplexer 18. This correction will then cancel out any errors caused by leakage current from integrator 22.

Those skilled in the art will further appreciate that the invention may be embodied in other specific forms without departing from the spirit or central attributes thereof. In that the foregoing description of the invention discloses only exemplary embodiments thereof, it is to be understood that other variations are contemplated as being within the scope of the invention. Accordingly, the invention is not limited to the particular embodiments which have been described in detail herein. Rather, reference should be made to the appended claims as indicative of the scope and content of the invention.

What is claimed is:

1. A method for enabling efficient synchronization of an optical disc drive with an optical media having a periodic timing structure and predefined data thereon, the method comprising the steps of:
operating in a wobble mode to receive a wobble signal proportional to the periodic timing structure and produce a clock signal which is locked to the received wobble signal, thus causing the clock signal to be synchronized with the rotation of the media; and
when necessary to provide more high speed synchronization, operating in a data mode to receive a data signal from the predefined data and thus produce the clock signal based thereon, wherein the clock signal is then synchronized with the timing of the predefined data.

2. The method of claim 1, wherein the step of operating in the wobble mode comprises the steps of comparing the wobble signal with the existing clock signal to produce a wobble error signal and adjusting the clock signal so as to minimize the wobble error signal.

3. The method of claim 1, wherein the step of operating in the data mode comprises the steps of processing the data signal to produce data timing information and comparing the data timing information with the existing clock signal to produce a data timing error signal, and adjusting the clock signal so as to minimize the data timing error signal.

4. The method of claim 3, wherein the clock signal is produced by an oscillator.

5. The method of claim 2, wherein the clock signal is produced by an oscillator.

6. The method of claim 1, wherein the media comprises an optical disc.

7. The method of claim 1 wherein the step of operating in the wobble mode comprises the steps of comparing the wobble signal with the existing clock signal to produce a wobble error signal and adjusting the clock signal so as to minimize the wobble error signal;
wherein the step of operating in the data mode comprises the steps of processing the data signal to produce data timing information and comparing the data timing information with the existing clock signal to produce a data timing error signal, and adjusting the clock signal so as to minimize the data timing error signal; and
wherein the mode of operation is controlled by a controller which produces a mode control signal which indicates whether the wobble error signal or the data timing error signal will be used to adjust the clock signal.

8. A system for enabling a disc drive to synchronize with multiple sources of information on a storage media, comprising:
an oscillator that produces a clock signal having a frequency which is dependent upon a signal received at an oscillator input;
a analog to digital converter that receives at least one data signal from the storage media and produces a digitized data signal corresponding to the at least one data signal;
a data phase detector for receiving the digitized data signal and the clock signal and produces a data phase error signal indicative of the phase error between the digitized data signal and the clock signal;
a wobble phase detector for receiving a wobble signal from the storage media and the clock signal, the wobble phase detector for further producing a wobble error signal indicative of the phase error between the wobble signal and the clock signal;
wherein either the wobble error signal or the data phase error signal are provided to the oscillator input depending upon whether the system is operating in the wobble mode or the data mode, respectively.

9. The system of claim 8, further comprising a multiplexer attached to data phase detector, wobble phase detector and the oscillator, the multiplexer for providing the wobble error signal to the oscillator when operating in the wobble mode, and for providing the data error signal to the oscillator when operating in the data mode.

10. The system of claim 9, further comprising a digital to analog converter for receiving the signal provided at the output of the multiplexer and converting it to an analog voltage signal which is provided to the oscillator input, wherein the oscillator output is dependent upon the analog voltage signal.

11. The system of claim 10, further comprising a lead/lag filter receiving the wobble error signal and providing a lag adjustment before transmitting the error signal to the multiplexer.

12. The system of claim 8, wherein the media comprises an optical disc.

13. The system of claim 8, wherein the wobble single is based upon a physical structure existing on the disk surface.

14. A dual mode timing control system for synchronizing a clock signal with timing information on a storage media, the dual mode timing control system comprising:
a wobble branch for receiving a wobble signal from the storage media and the clock signal, wherein the wobble signal corresponds to a physical structure on a surface of the media, the wobble branch for comparing the wobble signal and the clock signal and producing a wobble error signal at a wobble branch output;
a data branch for receiving a data signal which was recorded on the media using a predetermined clock signal and thus having a predetermined data structure and related timing information, the data branch also receiving the clock signal and comparing the timing information with the clock signal to produce a data error signal at a data branch output;
a multiplexer having inputs attached to the wobble branch output and the data branch output, the multiplexer having an output which is controlled by a control signal;
an analog branch which comprises a filter and a voltage controlled oscillator, the analog branch having an input attached to the multiplexer output to receive the data error signal or the wobble error signal depending on the status of the control signal, the analog branch having a clock output for producing the clock signal which is related error signal present at analog branch input.

15. The system of claim 14 wherein the data branch includes an analog to digital converter and a data phase detector.

16. The system of claim 14 wherein the wobble branch includes a wobble phase detector for producing the wobble phase error and a lead/lag filter for providing a timing adjustment to the wobble error signal.

17. The system of claim 14 wherein the media is an optical storage disk.
